(19) United States
(12) Patent Application Publication
(10) Pub. No.: US 2010/0303164 A1
(43) Pub. Date: Dec. 2, 2010

(54) BLOCK SPREADING FOR ORTHOGONAL FREQUENCY DIVSION MULTIPLE ACCESS SYSTEMS

(75) Inventors: Xiaojing Huang, New South Wales (AU); Yingjie Jay Guo, New South Wales (AU)

Correspondence Address: MERCHANT & GOULD PC, P.O. BOX 2903, MINNEAPOLIS, MN, 55402-0903, US

(73) Assignee: Commonwealth Scientific and Industial Research Organisation, Campbell (AU)

(21) Appl. No.: 12/811,156

(22) PCT Filed: Aug. 11, 2009
(86) PCT No.: PCT/AU2009/001023

§ 371 Date: Jun. 29, 2010

(30) Foreign Application Priority Data
Oct. 30, 2008 (AU) 2008905600

(51) Int. Cl. H04L 27/28

(52) U.S. Cl. 375/260

(57) ABSTRACT

A method of block spreading data, the method comprising the steps of: (a) providing a first input data sequence; (b) forming a periodic extension of the input data sequence to form an extended input data sequence; (c) multiplying the extended input data sequence by a complex number spreading sequence to produce a spread signal sequence; and (d) outputting the spread signal sequence.

### FIELD OF THE INVENTION

The present invention relates to information encoding and in particular discloses systems and methods for transmitting and receiving digital data information in an orthogonal frequency division multiple access (OFDMA) system in order to improve system performance.

### BACKGROUND

Orthogonal frequency division multiplexing (OFDM) and orthogonal frequency division multiple access (OFDMA) systems are believed to have the greatest potential to become the leading technologies in next generation wireless communication systems. In an OFDMA system, the total available bandwidth is divided into a number of narrowband subcarriers, and different groups of subcarriers are assigned to different users for multiuser communications. Due to the many advantages such as efficient intersymbol interference (ISI) mitigation, simple frequency domain channel equalization via fast Fourier transforms (FFT), as well as extended cell range for a given transmit power, this technique has been adopted in the IEEE 802.16e wireless metropolitan area network (WMAN) known as the mobile WiMAX (Worldwide Interoperability for Microwave Access) and the 3rd generation partnership project (3GPP) long term evolution (LTE) radio access network.

However, OFDMA systems also bring technological challenges, since transmitted signals have high peak-to-average power ratio (PAPR) and its performance is prone to frequency-selective fading. Therefore, extensive research has been undertaken to improve OFDMA system power efficiency and frequency diversity performance.

One technique to improve the frequency diversity in frequency-selective fading channels is the linear constellation precoding technique proposed for OFDM based systems. A similar technique known as block spread OFDM has also been proposed and the performance of the precoded or block spread OFDM has been analysed. The main idea of precoding or block spreading for OFDM is to obtain different linear combinations of the transmitted data symbols by linear transformation (via matrix multiplication) and then modulate the combined data symbols onto corresponding subcarriers in order to gain frequency diversity. After precoding or block spreading, an inverse fast Fourier transform (IFFT) is undertaken to produce the time domain signal.

In addition to the improved frequency diversity, the precoded or block spread OFDM signal may demonstrate reduced PAPR. The extent to which the PAPR can be reduced can depend on the specific transformation matrix and subcarrier allocation method. This technique has been adopted for the 3GPP LTE uplink, known as single carrier frequency division multiple access (SC-FDMA), where the precoding process is implemented by an FFT and subcarrier allocation is determined via a frequency hopping pattern.

In a wireless broadband system, there is an imminent need for lower PAPR signalling to achieve higher power efficiency (allowing a power amplifier to operate at saturation point). Though the precoded OFDM can improve the frequency diversity, the additional complexity is still a burden, and generally a lower PAPR can not be guaranteed.

### SUMMARY

It is an object of the present invention to provide improved block spreading for Orthogonal Frequency Division Multiple Access Systems.

In accordance with a first aspect of the present invention, there is provided a method of block spreading data, the method comprising the steps of: (a) providing a first input data sequence; (b) forming a periodic extension of the input data sequence to form an extended input data sequence; (c) multiplying the extended input data sequence by a complex number spreading sequence to produce a spread signal sequence; and (d) outputting the spread signal sequence. The step (b) further preferably can include scaling the input data sequence by a factor inversely proportional to the extended input data sequence length.

Further, the first input data sequence is preferably one of a series of substantially orthogonal data sequences and the method of block spreading data can be applied to each of the series of substantially orthogonal data sequences.

The method is very suitable for transmission of the spread signal sequence over a wireless network.

In accordance with a further aspect of the present invention, there is provided a transmitter system for transmitting an input data sequence, the transmitter including: a first data grouping unit dividing the input data sequence into a series of groups; a block spreading unit for block spreading each of the members of the group series, multiplying the members of the group with a complex exponential sequence to form a corresponding block spread series of groups; an adder for adding together corresponding members of each group to form a transmission group; a transmitter for transmitting the transmission group.

The system preferably further includes a cyclic prefix padding unit interconnection to the transmission group for adding cyclic prefixes to the transmission group before transmission.

The system preferably further includes a zero padded suffix unit for adding zero padded suffixes to the transmission group before transmission.

In accordance with a further aspect of the present invention, there is provided a receiver system for receiving a complex exponential block spread data sequence, the receiver system including: an input data symbol tokeniser receiving the complex exponential block spread data sequence; a series of block despreading units, each of the units interconnected to the tokeniser, each of the block despreading units multiplying a grouped version of the input data signals with a complex conjugate exponential to produce a series of substantially orthogonal transmitted data sequences; a series of phase rotation units for undertaking a predetermined phase rotation of each orthogonal transmitted data sequence to produce a corresponding rotated orthogonal transmitted data sequence; a regrouping unit connected to the phase rotation unit for reordering each of the rotated orthogonal transmitted data sequences to produce an output data sequence.

The receiver system can preferably further include initial cyclic prefix removal unit interconnected to the input data symbol tokeniser for removing cyclic prefixes from the complex exponential block spread data sequence.

The receiver system can preferably further include a zero padded suffix removal unit for removing zero padded suffixes from the complex exponential block spread data sequence.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a schematic illustration of a direct sequence spreading process;

FIG. 2 illustrates an example of direct sequence spreading;

FIG. 3 is a schematic illustration of a block spreading process;

FIG. 4 illustrates an example of a block spreading process;

FIG. 5 illustrates an example of block spreading with complex exponentials;

FIG. 6 illustrates a frequency domain representation of block spreading using complex exponentials;

FIG. 7 illustrates schematically an example transmitter implementing block spreading;

FIG. 8 illustrates schematically an example receiver implementing block despreading; and

FIG. 9 illustrates the block despreading process of FIG. 8 in more detail.

### DETAILED DESCRIPTION

Preferred embodiments of the invention will now be described, by way of example only, with reference to the accompanying drawings.

The preferred embodiment discloses a novel block spreading technique for OFDMA with improved diversity performance, high power efficiency, and low implementation complexity. Block spreading was first used with direct sequence and chip-interleaved block spread code division multiple access (DS-CDMA and CIBS-CDMA), where specially designed binary spreading sequences are used to achieve multiple access interference (MM) free at the cost of reduced system capacity. The proposed block spreading in the preferred embodiments, however, uses complex exponentials as the spreading sequences to realize OFDMA signalling with inherent frequency domain precoding, equally spaced subcarrier allocation and low signal PAPR. Compared with conventional precoded OFDMA, the OFDMA with the block spread signal is extremely simple since no explicit precoding or IFFT is normally required.

In traditional OFDMA data transmission, the high peak-to-average power ratio (PAPR) of the transmitted signal is always a serious issue which reduces the transmitter's power efficiency. The system has to normally either set a power back-off to allow the power amplifier to work in the linear region or use complicated algorithms to reduce the signal PAPR so that the power amplifier can work near the saturation point. Another issue is the poor frequency diversity performance of the OFDMA system in the frequency-selective fading channel. Channel coding and/or frequency diversity techniques such as precoding have to be used to improve the diversity performance, which adds more complexity to the implementation of the system.

The preferred embodiment solves the above problems by generating the OFDMA signal with block spreading. The block spread signal demonstrates lower PAPR so that the system power efficiency can be improved. The signal also efficiently achieves frequency precoding in the frequency domain so that the transmitter complexity can be reduced and the receiver can employ the corresponding equalization and detection techniques to improve the diversity performance.

The preferred embodiment is primarily for use in the area of future cellular networks. It offers a solution to the uplink of the 3G long term evolution (LTE) networks and can be used in future mobile and cellular networks such as 4G.

The preferred embodiments utilise a method to generate signals by block spreading with complex exponentials for orthogonal frequency division multiple access (OFDMA) systems to improve the system performance. The data symbols to be transmitted are first divided into blocks. Each block is then periodically extended to have multiple periods. The extended data block is further block spread by a complex exponential to form the block spread signal. Multiple data blocks can be block spread by complex exponentials with different frequencies respectively and then added together to form a combined block spread signal. The block spread signal demonstrates some unique properties, such as lower peak-to-average power ratio in the time domain and inherence frequency precoding in the frequency domain. When the block spread signals are used in an OFDMA system, the system power efficiency and frequency diversity can be improved greatly with lower complexity.

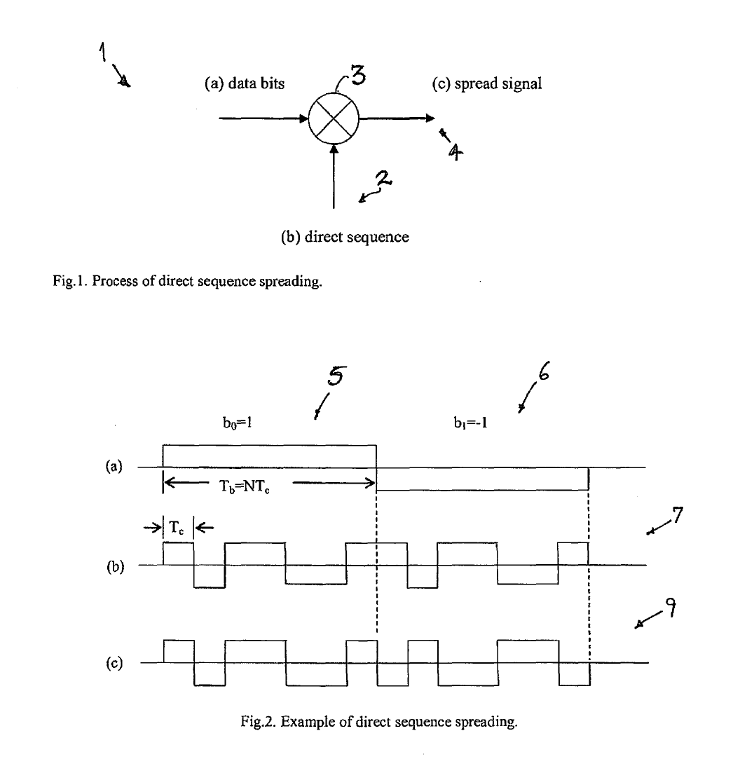

For better understanding of the block spreading concept of the preferred embodiments, the conventional direct sequence spreading process is first described with reference to FIG. 1 and FIG. 2.

FIG. 1 shows the process of direct sequence spreading. The input binary data bits 1 with bit duration T_{b} are multiplied 3 by a direct sequence 2 of length N with chip duration T_{c}=T_{b}/N, resulting in the direct sequence spread signal 4. An example of this direct sequence spreading can be as illustrated by FIG. 2, where two data bits b₀=1 (5) and b₁=−1 (6) are spread by a direct sequence of length N=7 (7), resulting in output spread signal 9.

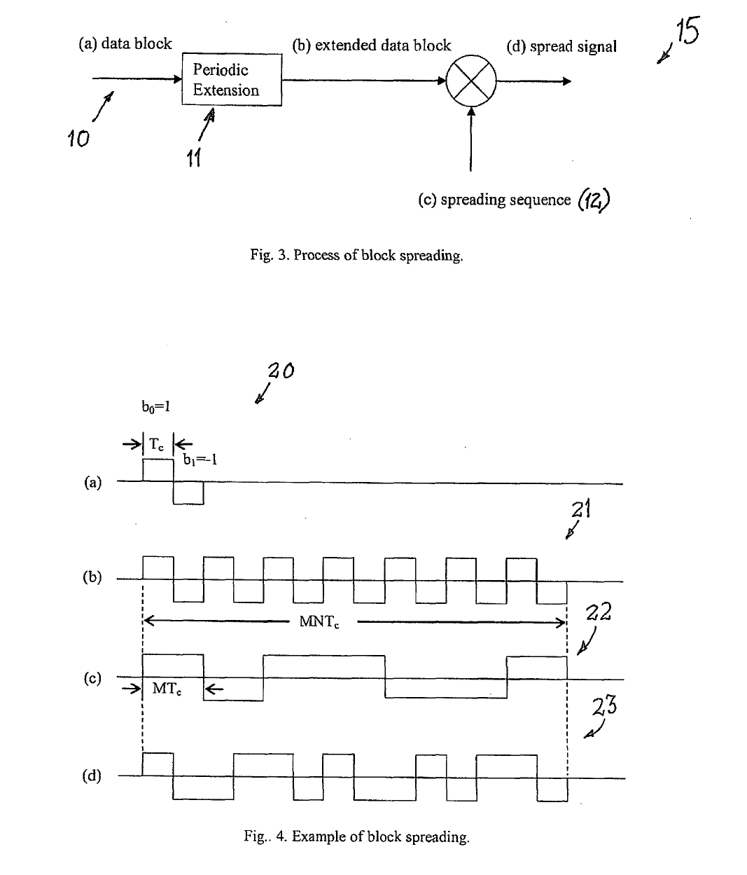

Block spreading spreads the data bits by blocks. An example of the process of block spreading is shown in FIG. 3, where the data block is input 10 of size M and is first periodically extended by N times 11 and then each data block is multiplied by a corresponding bit in the spreading sequence 12 of length N to produce an output block spread sequence 15 of length MN. An example of this block spreading is shown in FIG. 4, where the original data block 20 is {1, −1} with block size M=2 and chip time T_{c}, and the spreading sequence is the same as that in FIG. 2. The signal is first spread by a factor N (21), before being multiplied with a spreading sequence 22 to produce output 23.

In the preferred embodiment a number of further modifications are made. The block spreading is applied to data symbols after quadrature amplitude modulation (QAM) instead of binary data bits, and the spreading sequence is a complex exponential rather than a binary sequence.

To describe the method of the preferred embodiment block spreading mathematically, let x[m], m=0, 1, . . . , M−1, denote a block of M data symbols, and

$${c}_{K} [ n ] = {e}^{j \frac{2 π}{N} Kn} ,$$

n=0, 1, . . . , N−1, denote a complex exponential sequence of length N with discrete frequency index K. The spread signal γ[i], i=0, 1, . . . , MN−1, is generated by extending the input data sequence x[m] periodically into N periods with a scaling factor 1/N and then multiplying each period by a corresponding element of c_{K}[n]. The resulting block spread signal can be expressed as:

$$y [ i ] = \frac{1}{N} x [ m ] {c}_{K} [ n ] = \frac{1}{N} x [ m ] {e}^{j \frac{2 π}{N} Kn} , \\ i = nM + m , m = 0 , 1 , … , M - 1 , n = 0 , 1 , … , N - 1.$$

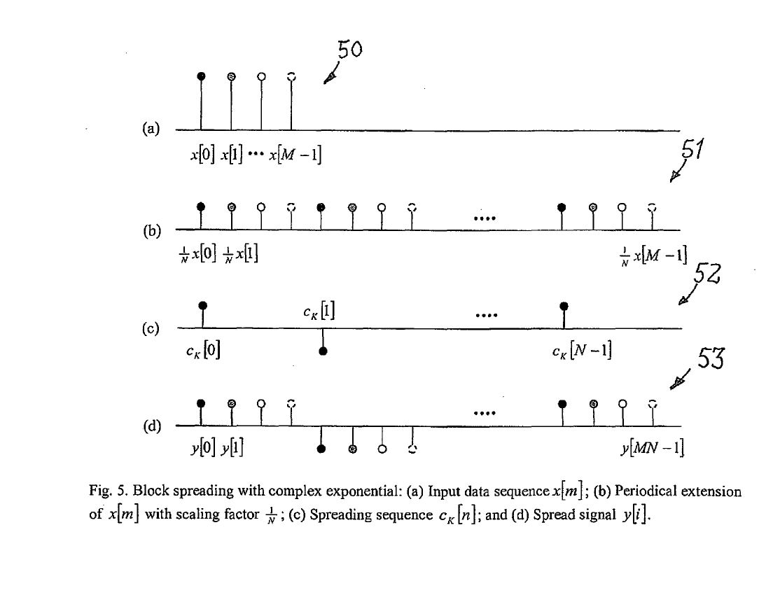

An example of the block spreading using complex exponentials is shown in FIG. 5, where the time domain signal waveforms (at the test points 10 in FIG. 3) are replaced by discrete signal sequences 50 since the block spreading is implemented in the digital domain. The signal is first periodically extended with scaling factor

$$\frac{1}{N} 51.$$

The resultant signal 51 is then multiplied by the spreading sequence 52 to produce output signal γ[i] 53.

The block spread signal 53 has some particularly desired properties, which are useful in OFDMA systems for wireless communications. Firstly, since the complex exponential spreading sequence has a constant envelop, the spread signal can have constant envelop too provided that the data symbol has a constant amplitude. When 2^{k}-ary (QAM) (k even) constellation mapping is used, the PAPR can be expressed as

$$\frac{3 {( {2}^{k / 2} - 1 )}^{2}}{{2}^{k} - 1} ,$$

which are 1, 1.80, 2.33 and 2.65 for quadrature phase shift keying (QPSK), 16QAM, 64QAM and 256QAM (k=2, 4, 6 and 8) respectively.

Secondly, the block spread signal using complex exponentials has an inherent precoding effect in the frequency domain, which can be exploited to improve the frequency diversity performance if the signal is used in an OFDMA system. To show this inherent precoding, the discrete Fourier transform (DFT) of y[i] can be expressed as:

$$\begin{matrix}Y [ k ] = {\sum }_{i = 0}^{MN - 1} y [ i ] {e}^{- j \frac{2 π}{MN} ki} \\ {=}^{k = lN + K} {\sum }_{m = 0}^{M - 1} x [ m ] {e}^{- j \frac{2 π}{M} ( l + \frac{K}{N} ) m} = \{ \begin{matrix}X ( {e}^{j \frac{2 π}{M} ( I + \frac{K}{N} )} ) , & \begin{matrix}k = lN + K , \\ l = 0 , 1 , … , M - 1\end{matrix} \\ 0 , & otherwise\end{matrix}\end{matrix}$$

where X(e^{jw}) denotes the Fourier transform of the sequence x[m], and

$$X ( {e}^{j \frac{2 π}{M} ( l + \frac{K}{N} )} )$$

is the sampled

$$X ( {e}^{jω} ) at ω = \frac{2 π}{M} ( l + \frac{K}{N} ) . X ( {e}^{j \frac{2 π}{M} ( l + \frac{K}{N} )} )$$

can be also interpreted as the M-point DFT of the phase shifted sequence

$$x [ m ] {e}^{- j \frac{2 π}{MN} Km} .$$

This phase shifting will be referred to as down-shifting hereafter since it corresponds to shifting X(e^{jw}) downwards by a digital frequency offset

$$\frac{2 π K}{MN} .$$

This can be shown by taking the Fourier transform of

$$x [ m ] {e}^{- j \frac{2 π}{MN} Km} ,$$

which is

$${\sum }_{m = 0}^{M - 1} x [ m ] {e}^{- j \frac{2 π}{MN} Km} {e}^{- jω m} = {\sum }_{m = 0}^{M - 1} x [ m ] {e}^{- j ( ω + \frac{2 π}{MN} Km )} = X ( {e}^{j ( ω + \frac{2 π K}{MN} )} ) .$$

We see that X(e^{jw}) is shifted downward by a digital frequency offset

$$\frac{2 π K}{MN}$$

after phase shifting the sequence x[m] by the factor

$${e}^{- j \frac{2 π}{MN} Km} .$$

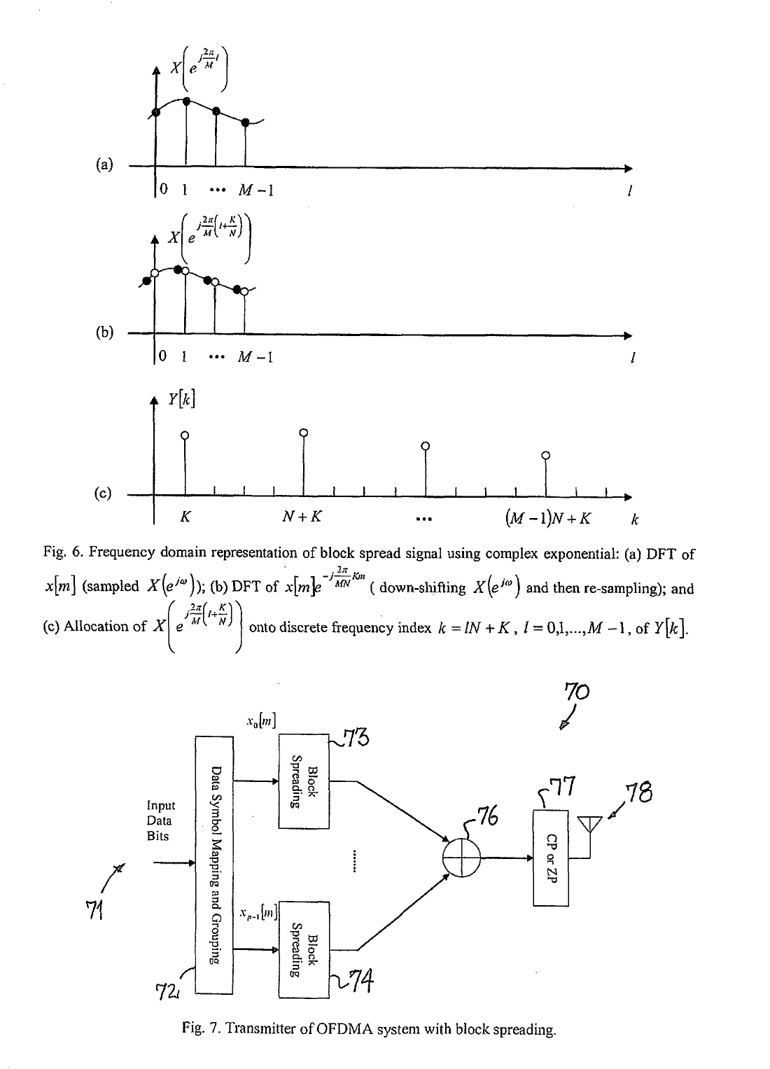

The frequency domain representation is illustrated in FIG. 6.

One form of implementation of a transmitter of an OFDMA system utilizing the method of the preferred embodiment with block spreading is shown schematically 70 in FIG. 7. The input data bits 71 are first mapped into data symbols and grouped into p blocks of size M. The p data symbol blocks are denoted as x₀[m] to xₚ₋₁[m]. The data symbol blocks are then spread by respective complex exponentials

$${c}_{{K}_{0}} [ n ] = {e}^{j \frac{2 π}{N} {K}_{0} n} to {c}_{{K}_{p - 1}} [ n ] = {e}^{j \frac{2 π}{N} {K}_{p - 1} n}$$

via block spreading units e.g. 73, 74, where K₀ to Kₚ₋₁ are chosen from numbers 0 to N−1 but different from each other. The spread signals are further summed up 76, and either a cyclic prefix (CP) or a zero-padded (ZP) suffix of sufficient length is added 77 to the combined signal to form an OFDMA symbol for output 78. It can be seen that this transmitter 70 is very simple, where no explicit precoding or IFFT is required.

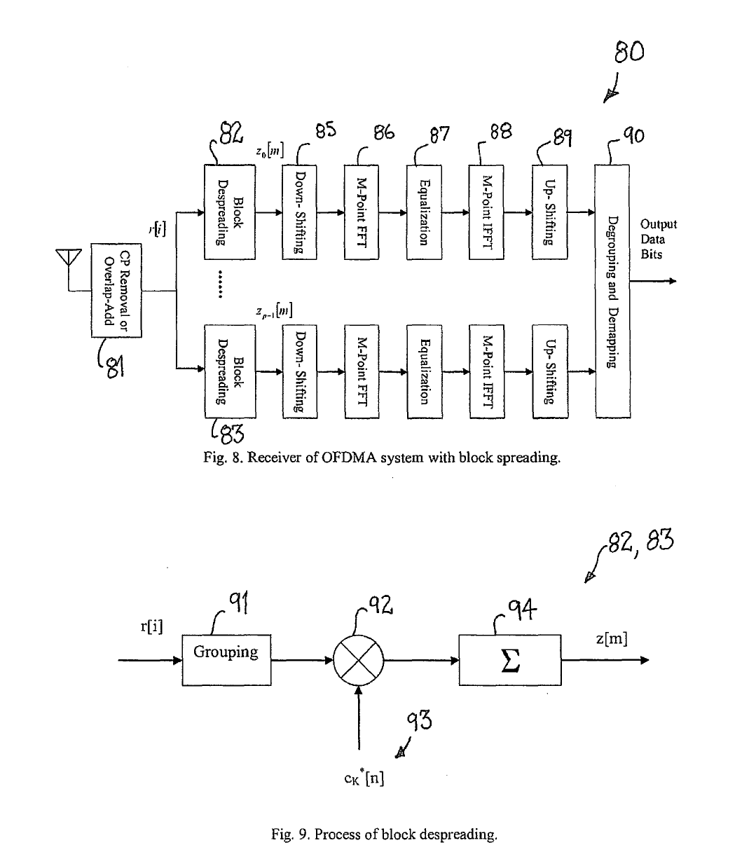

An example of one form of implementation of a corresponding receiver 80 is shown schematically in FIG. 8. The received OFDMA symbol is first passed through a CP Removal or Overlap-Add module 81 to produce an MN point baseband signal r[i]. Then, r[i] is despread e.g. 82, 83 by the conjugated complex exponentials

$${c}_{{K}_{0}}^{*} [ n ] = {e}^{- j \frac{2 π}{N} {K}_{0} n} to {c}_{{K}_{p - 1}}^{*} [ n ] = {e}^{- j \frac{2 π}{N} {K}_{p - 1} n}$$

respectively to obtain the block despread signals z₀ [m] to zₚ₋₁[m].

The block dispreading step e.g. 82, 83 is shown in more detail in FIG. 9. Assuming a complex exponential frequency index K and the despread signal z[m], first, r[i] is grouped into N blocks of size M 91 and each block is multiplied 92 by a corresponding element 93 of

$${c}_{K}^{*} [ n ] = {e}^{- j \frac{2 π}{N} Kn} .$$

Then the corresponding products for all blocks are summed 94. Mathematically, the block despread signal can be expressed as

$$\begin{matrix}z [ m ] = {\sum }_{n = 0}^{N - 1} r [ nM + m ] {e}^{- j \frac{2 π}{N} Kn} \\ = {e}^{j \frac{2 π}{MN} Km} \frac{1}{M} {\sum }_{l = 0}^{M - 1} R [ lN + K ] {e}^{j \frac{2 π}{M} lm} , m = 0 , 1 , … , M - 1 ,\end{matrix}$$

where R[k] is the DFT of r[i]. After block dispreading, the same process is followed to recover data symbol blocks x₀[m] to xₚ₋₁[m] from z₀[m] to zₚ₋₁[m] respectively. For simplicity, the subscript will be ignored when describing this process as follows.

First, the block despread signal z[m] is down-shifted 85 by phase rotations

$${e}^{- j \frac{2 π}{MN} Km}$$

to
obtain

$$\frac{1}{M} {\sum }_{l = 0}^{M - 1} R [ lN + K ] {e}^{j \frac{2 π}{M} lm} .$$

Second, M-point FFT is performed 86 to obtain the received frequency domain signal R[lN+K], l=0, 1, . . . , M−1. Third, equalization is performed 87, to recover Y[lN+K]. Finally, x[m] can be retrieved after performing M-point IFFT 88 and phase shifting

$${e}^{j \frac{2 π}{MN} Km}$$

89 (i.e., up-shift). After all x₀[m] to xₚ₋₁[m] are retrieved, degrouping and demapping 90 are followed to produce the output data bits.

The above transmitter and receiver are suitable for both uplink and downlink of an OFDMA system. The parameters M, N, p, and K₀ to Kₚ₋₁ can be used to determine the number of subcarriers used in the system, the number of data symbols transmitted from or received by a user and how many subcarriers are allocated for users.

In summary, the preferred embodiments include the following advantageous features: The use of multiple block spread signals with different complex exponentials in an OFDMA system. A transmitter architecture without explicit precoding or IFFT requirements. A block despreading method which reveals the relationship between the DFT of the signal before block despreading and the signal after block dispreading and a receiver architecture which makes use of the above relationship to efficiently recover the transmitted data symbols and achieve improved frequency diversity performance.

### Interpretation

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Although the present invention has been described with particular reference to certain preferred embodiments thereof, variations and modifications of the present invention can be effected within the spirit and scope of the following claims.

1. A method of block spreading input data sequences, the method comprising the steps of:
(a) providing a first input data sequence;
(b) forming a periodic extension of the input data sequence to form an extended input data sequence;
(c) multiplying the extended input data sequence by a complex number spreading sequence to produce a spread signal sequence; and
(d) outputting the spread signal sequence.

2. A method as claimed in claim 1 wherein said step (b) further includes scaling the input data sequence by a factor inversely proportional to the extended input data sequence length.

3. A method as claimed claim 1 wherein said first input data sequence is one of a series of substantially orthogonal data sequences and said method of block spreading data is applied to each of the series of substantially orthogonal data sequences.

4. A method as claimed in claim 1, further comprising the steps of: (e) transmitting the spread signal sequence over a wireless network.

5. A transmitter system for transmitting an input data sequence, the transmitter including: a first data grouping unit dividing the input data sequence into a series of groups; a block spreading unit for block spreading each of the members of the group series, multiplying the members of the group with a complex exponential sequence to form a corresponding block spread series of groups; an adder for adding together corresponding members of each group to form a transmission group; a transmitter for transmitting the transmission group.

6. A transmitter system as claimed in claim 5 further including a cyclic prefix padding unit interconnection to the transmission group for adding cyclic prefixes to the transmission group before transmission.

7. A transmitter system as claimed in claim 5 further comprising a zero padded suffix unit for adding zero padded suffixes to the transmission group before transmission.

8. A receiver system for receiving a complex exponential block spread data sequence, the receiver system including: an input data symbol tokeniser receiving the complex exponential block spread data sequence; a series of block despreading units, each of the units interconnected to the tokeniser, each of said block despreading units multiplying a grouped version of the input data signals with a complex conjugate exponential to produce a series of substantially orthogonal transmitted data sequences; a series of phase rotation units for undertaking a predetermined phase rotation of each orthogonal transmitted data sequence to produce a corresponding rotated orthogonal transmitted data sequence; a regrouping unit connected to the phase rotation unit for reordering each of the rotated orthogonal transmitted data sequences to produce an output data sequence.

9. A receiver system as claimed in claim 8 further including: an initial cyclic prefix removal unit interconnected to the input data symbol tokeniser for removing cyclic prefixes from the complex exponential block spread data sequence.

10. A receiver system as claimed in claim 8 further including a zero padded suffix removal unit for removing zero padded suffixes from the complex exponential block spread data sequence.
